(19) United States
(12) Patent Application Publication
(10) Pub. No.: US 2015/0025707 A1
(43) Pub. Date: Jan. 22, 2015

(54) METHOD AND APPARATUS FOR DIAGNOSING INERTIA SENSOR

(71) Applicants: Greg Morningstar, Canton, MI (US); Mike Babala, Plymouth, MI (US); Paul Zatyko, Westland, MI (US)

(72) Inventors: Greg Morningstar, Canton, MI (US); Mike Babala, Plymouth, MI (US); Paul Zatyko, Westland, MI (US)

(21) Appl. No.: 14/380,833

(22) PCT Filed: Mar. 1, 2013
(86) PCT No.: PCT/US13/28645

§ 371 Date: Aug. 25, 2014

Related U.S. Application Data
(60) Provisional application No. 61/607,053, filed on Mar. 6, 2012.

(51) Int. Cl. G01P 21/00; B60W 40/10; B60W 30/02; G01C 25/00

(52) U.S. Cl. CPC G01P 21/00; G01C 25/00; B60W 40/10; B60W 30/02
USPC 701/1; 73/1.38

(57) ABSTRACT

A control system adapted to be mounted on a motor vehicle for control of a motor vehicle system in accordance with the inertial state of the motor vehicle. The control system includes an inertial sensor providing an inertial measurement output in accordance with the inertial state of the motor vehicle, where the inertial measurement output is referenced to a reference voltage. A controller is provided for controlling the motor vehicle system at least partially in accordance with the inertial measurement output. The controller includes a circuit for comparing the reference voltage used by the inertial sensor to a nominal voltage. The circuit causes the controller to discontinue use of the inertial measurement output when the reference voltage deviates from the nominal voltage.

### FIELD OF THE INVENTION

The present invention is directed to a diagnostic method and apparatus for use with inertia sensors, particularly for use in motor vehicles.

### BACKGROUND

Increasing numbers of inertia sensors are being installed in motor vehicle systems. Such sensors provide valuable vehicle state information to controllers for such diverse systems as occupant restraints (e.g., airbags, seat belt pretensioners, etc.) and vehicle stability control (e.g. braking, steering systems, etc.). If the inertia sensors fail to operate properly, then the associated system may be degraded as well.

Inertia sensors sometimes include built in self test (“BIST”) functions for assessing the operation of the sensor. BIST functions are helpful in detecting failures of the sensors. However, BIST functions may fail to reveal some types of degradation of the sensor operation, particularly those types of degradation that are associated with interaction between the sensor and the rest of the system.

### SUMMARY OF THE INVENTION

Electronic systems in motor vehicles have single-ended power supplies, since the vehicle battery itself is single-ended. Inertial sensors, whether accelerometers or gyros, often must allow their inertial measurement outputs to swing positive (above a reference) or negative (below a reference), respectively representing positive or negative angular velocity (angular “rate”), for example. Therefore, conventionally, the inertial sensor will define some reference level that is intermediate between ground and the voltage of the available power supply. The reference level must be steady, as any change in the reference level will be mirrored by a change in the output level, and a consequent degradation in the accuracy of the inertial measurement output.

The present invention provides a method and operation for detection of spurious outputs from an inertial sensor by detecting a deviation of a reference voltage from its design level.

### BRIEF DESCRIPTION OF THE DRAWINGS

The foregoing and other features and advantages of the present invention will become apparent to those skilled in the art to which the present invention relates upon reading the following description with reference to the accompanying drawings, in which:

FIG. 1 is a block diagram of a vehicle system in accordance with one example embodiment of the present invention; and

FIG. 2 is a flow chart showing a control process in accordance with one example embodiment of the present invention.

### DETAILED DESCRIPTION

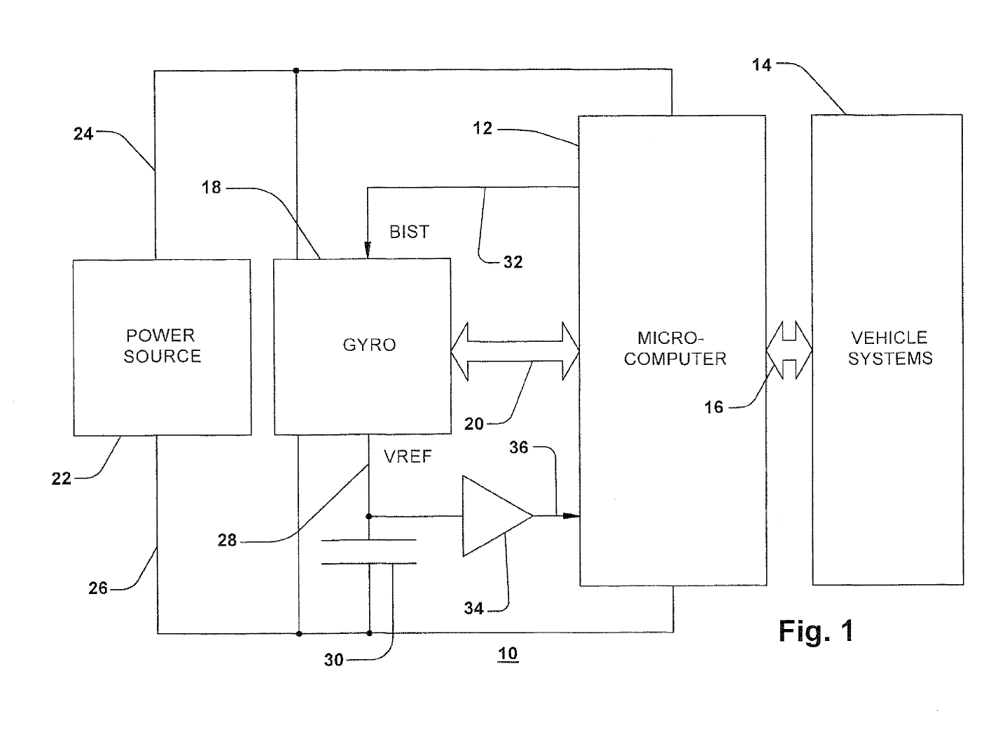

Referring to FIG. 1, an electronic control system 10 for a motor vehicle, such as a passenger car, truck, or SUV, includes a controller 12. The controller 12 may be a microcomputer and is illustrated as such in the figure. The microcomputer is not described in detail herein, but is understood to contain the elements typical of such microcomputers, including a single or multiple core microprocessor, appropriate read-only and random access memories, input/output controllers, digital and analog inputs, analog to digital convertors, and so on. The microprocessor(s) operates under control of the software/firmware program stored in the memory of the microcontroller. The controller may also be embodied using discrete circuitry, an application-specific integrated circuit, etc., designed to accomplish the desired functions.

Microcomputer 12 is connected to the vehicle systems 14 via various control lines 16, and controls the operation of such systems via those control lines. The controller 12 may be designed and programmed as a vehicle stability controller, in which case the controlled vehicle systems 14 will be such things as electro-hydraulic braking systems and steering systems. Alternately, the controller 12 may be designed and programmed as a vehicle safety system controller, in which case the controlled vehicle systems 14 will be such things air bag initiators and seat belt pretensioners.

The microcomputer 12 is connected to various sensors that provide the controller with information reflecting the present state of the motor vehicle. The sensor set may include linear accelerometers such as single, double, or triple axis accelerometers, and may also include so called “rate sensors” or “gyros” which respond to angular rate of the vehicle and provide to the microcomputer 12 measurements of such angular rate. In the illustrated example embodiment, only one sensor, a gyro 18, is shown, connected to the microcomputer via a number of input/output lines 20. Other sensors may, however, also be included.

The electronic control system 10 is powered by a DC voltage supplied by a power source 22. The power source receives power from the vehicle electrical system, usually a wet-cell battery and appropriate charging circuitry. Power from power source 22 is single-ended, meaning that the power source only supplies power at voltage levels that are on one side of vehicle ground. That voltage will typically be derived from the 12 volt battery voltage, and may be, for example, 3 volts DC. The supply voltage V_{dd} will be provided via a supply lead 24, and of course the power source will be grounded to signal or vehicle ground, as indicated by ground lead 26. In FIG. 1, for convenience of illustration, both the microcomputer 12 and gyro 18 are shown as connected across the same power leads 24 and 26. In a particular embodiment, however, the source 22 may in fact supply different supply voltages to the gyro and the microcomputer via associated supply outputs. In either case, the gyro 18 is powered by a single-ended power supply.

Gyro 18 is an integrated circuit having various elements contained in a single sealed package with input/output pins for connection to external circuit elements. Gyro 18 is of generally conventional construction, and includes a sensor element and control circuitry. An example of one such a gyro is the Pinpoint CRM100 gyroscope manufactured by Silicon Sensing Systems Limited. (The content and operation of the CRM100 gyro is described in a datasheet available on the manufacturer's public website.) Microcomputer 12 triggers gyro 18 via control lines 20 to measure vehicle angular rate and provide the resulting angular rate measurement to the microcomputer as an analog signal via lines 20.

Proper functioning of gyro 18 is important to the proper functioning of the electronic control system 10. Sensors such as gyro 18 therefore often include a built-in self test (“BIST”) function for testing operation of the sensor. In FIG. 1, the microcomputer 12 has an output line 32 (illustrated as separate from lines 20 only for convenience of description) for triggering the BIST function of the sensor. The BIST function is triggered, for example, each time the vehicle is started up. The results of the BIST are supplied to microcomputer 12 via one of the input/output lines 20

In any given plane (roll, pitch, yaw), the vehicle may rotate in two different directions, clockwise or counterclockwise. The analog output of the gyro must therefore indicate not only the magnitude of the angular rate, but also the direction. The gyro 18 does this by establishing an artificial reference signal VREF midway between the supply voltage V_{dd} and ground. In the present example embodiment, V_{dd} is 3 volts and VREF is 1.5 volts. If the analog output of the gyro is above VREF, then the rate is assumed to be in one direction (e.g. clockwise). If the analog output of the gyro is below VREF, then the rate is assumed to be in the opposite direction (e.g. counterclockwise).

The accuracy of the analog output of the gyro 18 is dependent upon the accuracy of the reference voltage VREF. To stabilize VREF, the internal reference voltage line of the gyro 18 is attached to an output pin 28, adapted for connection to an external capacitor 30. Despite the stabilizing effect of the external capacitor 30, it is still possible that the reference voltage will drift or otherwise deviate from the preferred, nominal voltage. Moreover, a shift in VREF may indicate other problems with the gyro 18, e.g. a bad capacitor, an open ground connection, or an open connection from V_{dd} to the gyro 18.

In accordance with the present invention, the circuit is designed to measure the reference voltage (sometimes referred to as “reading” the reference voltage) each time the analog output of gryo 18 is read. If VREF deviates from the nominal level, the gryo reading is discarded and an error flag is set. Thus, bad readings due to reference voltage changes are invalidated and not used.

To this end, the electronic control system 10 further may include a buffer amplifier 34 providing a buffered signal equal to VREF. The buffered reference signal is supplied to an input of microcomputer 12 on analog input line 36. The microcomputer 12, as stated previously, includes an analog to digital convertor. The microcomputer also includes a multiplexer that allows it to connect any one of several inputs to the input of the analog to digital convertor. When microcomputer 12 requires a measurement of angular rate, it will first connect the buffered VREF signal on analog input line 36 to the analog to digital convertor, thereby taking a measurement of the reference value, and then will connect the analog output of gyro 18 to the analog to digital convertor, thereby taking a measurement of the gyro output. The digitalized version of the reference signal VREF will be compared with upper and lower thresholds, respectively above and below the nominal reference signal value. If the digitized version of the reference signal is above the upper threshold or below the lower threshold, the gyro output reading will be flagged as invalid and will not be used in the vehicle stability control algorithms or restraint control algorithms implemented in the microcomputer.

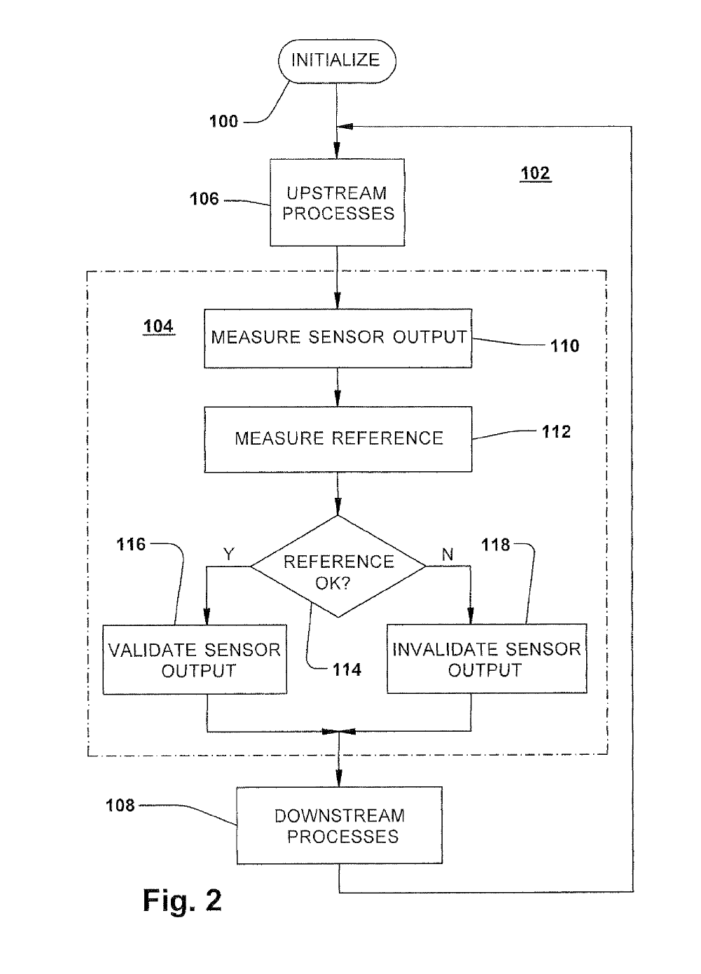

The microcomputer control process in accordance with an example embodiment of the present invention is shown in flowchart form in FIG. 2. The flowchart shows the measurement process as part of a larger software program performed by microcomputer 12. The program generally includes an initialization step 100 performed on key-on of the vehicle (ignition switch in the start or run position) in which initial flags are set, memories cleared, etc., and a main loop 102 that is cycled through repeatedly until key-off of the vehicle (ignition switch in the off position). Interrupt-driven processes will exist as well but these are not shown in FIG. 2. The measurement subroutine 104 is shown here as part of the main loop 102, however it could instead be part of an interrupt driven process performed periodically under timer control.

In the main loop, the measurement subroutine is preceded by other processes, collectively represented by upstream processes 106, and is also followed by other processes, collectively represented by downstream processes 108. The upstream processes may include housekeeping functions, diagnostics, preliminary algorithms, and capture of data from other sensors and systems. The downstream processes may include control algorithms employing the sensor data collected in measurement subroutine 104 and other upstream processes, interaction with controlled elements on the vehicle systems 14 (including controls of dashboard displays), and error processing routines.

Each time the main loop 102 cycles through the measurement subroutine 104, the microcomputer reads the output of the gryo 18 at step 110 and reads the reference voltage VREF provided by buffer amplifier 34 at step 112. In the succeeding evaluation step 114, the reference voltage VREF is evaluated. As described above, the evaluation step 114 comprises a comparison of the reference voltage VREF with an acceptable range or “window”, where the threshold window is defined by upper and lower limits against which VREF is separately compared. The design nominal value for VREF will typically be halfway between the upper and lower limits. If VREF is within the acceptable window (below the upper limit AND above the lower limit), the sensor output reading is validated in step 116 by resetting an error flag. Otherwise (VREF is EITHER above the upper limit OR below the lower limit), the sensor reading is invalidated in step 118 by setting same error flag.

In either case, program flow continues with downstream processes 108, where actions will be taken conditional upon the logic status of the error flag. Specifically, the gyro sensor reading will be used in further algorithmic processes only if the error flag is not set (i.e., is reset). If the error flag is set, however, then the downstream processes 108 will sense the flag status and will react by not using the sensor output reading. Further, the error flag will trigger the downstream processes 108 to (a) alert the vehicle operator of the error by illuminating a warning lamp, and (b) mitigate the effect of the unreliability of the sensor output by substitution of other sensors readings or by other modification of the algorithmic control processes.

A method and apparatus have thus been described for detection of spurious outputs from an inertial sensor by detecting a deviation of a reference voltage from its design level. Although described with specific reference to a gyro, which measures angular rate, the approach will be of equal value with any other sensors using VREF architectures similar to the example architecture outlined above. The approach will work with digital sensors as well as analog sensors, so long as the internal VREF signal may be accessed.

From the above description of the invention, those skilled in the art will perceive improvements, changes and modifications. Such improvements, changes and modifications within the skill of the art are intended to be covered by the appended claims.

Having described the invention, the following is claimed:

1. Apparatus for providing inertial measurements, comprising an inertial sensor providing an inertial measurement output referenced to a reference value, and a circuit for evaluating the reference value and for selectively using the inertial measurement output in response to said evaluation.

2. Apparatus as set forth in claim 1, wherein an inertial measurement output equal to said reference value denotes zero angular rate of said sensor.

3. Apparatus as set forth in claim 1, wherein said evaluating circuit accepts or rejects said inertial measurement output in response to said evaluation.

4. Apparatus as set forth in claim 1, wherein said evaluation circuit rejects said inertial measurement output unless said reference is at or near a nominal value.

5. Apparatus as set forth in claim 1, wherein said inertial sensor is adapted to be powered by a DC power signal that is single ended, and said reference is generally midway between said DC power signal and ground.

6. A control system adapted to be mounted on a motor vehicle for control of a motor vehicle system in accordance with the inertial state of the motor vehicle, comprising:
an inertial sensor providing an inertial measurement output that changes in accordance with the inertial state of the motor vehicle, where said sensor generates a reference voltage corresponding to a detected inertial rate of zero, and references said output to said reference voltage; and,
a controller for using the inertial measurement output to control the motor vehicle system;
wherein said controller includes a circuit for comparing the reference voltage to a nominal voltage and for causing said controller to discontinue use of said inertial measurement output when said reference voltage deviates from said nominal voltage.

7. A control system as set forth in claim 6, wherein the motor vehicle system is a vehicle stability control system, and wherein said controller controls said vehicle stability control system at least partial in accordance with said inertial measurement output.

8. A control system in accordance with claim 6, wherein said inertial sensor is an integrated circuit designed to be powered by a single-ended power supply, said integrated circuit housed within a sealed package having a plurality of pins for connection to circuit elements outside of said integrated circuit, wherein said integrated circuit includes a reference voltage source for producing a reference voltage generally in the middle of the voltage of said single-ended power supply and supplies said reference voltage on one of said pins, and wherein said circuit for comparing is connected to said one of said pins and determines whether said reference voltage is within an allowed range bounded on either side of said nominal voltage.

9. A control system as set forth in claim 8, wherein said inertial sensor is a gyro and said inertial measurement output varies as angular rate of said motor vehicle in at least one angular direction.

10. A method for providing inertial measurements, comprising the steps of:
generating a reference value;
measuring inertia and outputting an inertial measurement value that is referenced to said reference value;
evaluating said reference value and selectively using the inertial measurement value in response to said evaluation.

11. A method as set forth in claim 10, wherein said step of evaluating includes the steps of detecting when said reference value has deviated from a nominal value and changing the manner of use of said inertial measurement value when said reference value deviation is detected.

12. A method as set forth in claim 11, and further comprising the step of indicating an error when said deviation from a nominal value is detected.

13. A method as set forth in claim 10, wherein said step of evaluating comprises the step of using said inertial measurement value only when said reference value is at or near a nominal value.

14. A method as set forth in claim 10, wherein said step of measuring inertia and outputting an inertial measurement value includes the step of measuring angular rate and outputting an angular rate value that is referenced to said reference value.
